(19) United States
(12) Patent Application Publication
(10) Pub. No.: US 2015/0083561 A1
(43) Pub. Date: Mar. 26, 2015

(54) METAL KEYCAPS WITH BACKLIGHTING

(71) Applicants: Amy Han, Palo Alto, CA (US); Lawrence Lam, San Jose, CA (US)

(72) Inventors: Amy Han, Palo Alto, CA (US); Lawrence Lam, San Jose, CA (US)

(73) Assignee: GOOGLE INC., Mountain View, CA (US)

(21) Appl. No.: 13/077,134

(22) Filed: Mar. 31, 2011

(51) Int. Cl. H01H 13/02; C23F 1/04; B23H 9/14

(52) U.S. Cl. 200/314; 264/400; 216/56

(57) ABSTRACT

According to one general aspect of the invention, a keyboard of a computing device includes a keycap and a light source. The keycap is configured to actuate a switch of the computing device. The keycap includes a metal material and has an upper surface and a lower surface. The upper surface of the keycap is configured to be viewed by a user while operating the computing device and defines one or more openings in the keycap. The one or more openings in the upper surface is patterned in the shape of a single alphanumeric character. The lower surface of the keycap defines one or more openings in the keycap. The keycap defines one or more passageways extending from the one or more openings defined by the upper surface of the keycap through the keycap to the one or more openings defined by the lower surface of the keycap. The light source is configured to emit light through the one or more passageways of the keycap from the lower surface side of the one or more passageways to the upper surface side of the one or more passageways.

### TECHNICAL FIELD

This description relates to keycaps for an input and more particularly backlight keycaps for a computer keyboard.

### BACKGROUND

Keycaps are typically used to cover and actuate or activate switches of electronic input devices. For example, keycaps are used to cover and activate the switches or keys of a computer keyboard. The keycaps typically include a symbol, such as a letter or number, which indicates the function or association of the switch that is activated by that particular keycap. For example, on a keyboard, when the keycap marked with the letter “a” is depressed, the switch associated with the “a” keycap is actuated. Often, when the keyboard is in communication with a word processor or a computer that is running word processing software, the depression of the “a” keycap and the associated actuation of the “a” switch causes the letter “a” to be introduced into the document that is being created.

Sometimes, the markings on keycaps include an ink or paint marking. Sometimes, the markings on the keycaps are illuminated or are backlight.

Keyboards and keycaps that include backlighting, however, tend to be thicker than non-backlight keyboards and keycaps. Such keyboards and keycaps may be undesirable in devices, such as laptop computers, that are intended to be thin.

### SUMMARY

According to one general aspect of the invention, a keyboard of a computing device includes a keycap and a light source. The keycap is configured to actuate a switch of the computing device. The keycap includes a metal material and has an upper surface and a lower surface. The upper surface of the keycap is configured to be viewed by a user while operating the computing device and defines one or more openings in the keycap. The one or more openings in the upper surface is patterned in the shape of an alphanumeric character. The lower surface of the keycap defines one or more openings in the keycap. The keycap defines one or more passageways extending from the one or more openings defined by the upper surface of the keycap through the keycap to the one or more openings defined by the lower surface of the keycap. The light source is configured to emit light through the one or more passageways of the keycap from the lower surface side of the one or more passageways to the upper surface side of the one or more passageways.

According to another general aspect of the invention, a keycap includes and upper surface, a lower surface, and a side surface. The upper surface defines one or more openings. The one or more openings defined by the upper surface form an alphanumeric character. The lower surface defines one or more openings. The keycap is configured to actuate a switch of a keyboard of a computing device. The keycap includes a metal material and defines one or more passageways extending from the one or more openings defined by the upper surface through the keycap to the one or more openings defined by the lower surface.

According to another general aspect of the invention, a method includes creating a keycap from a metal material and creating a passageway extending through the keycap from a first surface of the keycap to a second surface of the keycap. The first surface being opposite the second surface.

The details of one or more implementations are set forth in the accompanying drawings and the description below. Other features will be apparent from the description and drawings, and from the claims.

### BRIEF DESCRIPTION OF THE DRAWINGS

FIG. 1 is a schematic diagram of a keycap assembly.

FIG. 2 is a top view of an example keycap assembly.

FIG. 3 is a cross-sectional view of the keycap assembly of FIG. 2 taken along line A-A of FIG. 2.

FIG. 3A is a top view of a portion of a keyboard and a keycap assembly.

FIG. 3B is a cross-sectional view of the portion of the keyboard and keycap assembly of FIG. 3A.

FIG. 4 is a top view of another example keycap assembly.

FIG. 5 is a perspective view of a keyboard and an associated computer monitor.

FIG. 6 is a perspective view of a laptop computer.

FIG. 7 is a flowchart of a method of forming a keycap.

### DETAILED DESCRIPTION

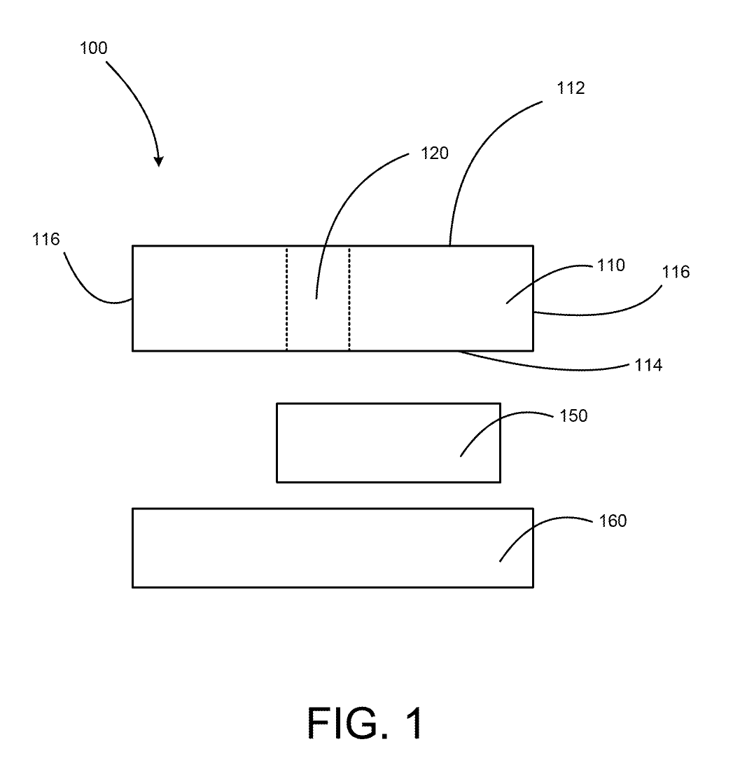

FIG. 1 is a schematic diagram of a keycap assembly 100. The keycap assembly 100 includes a keycap 110, a switch 150, and a light source 160. The keycap assembly 100 may be incorporated within an input of an electronic device. The keycap assembly 100 may be included within a keyboard or other type of input device. In some implementations, a keyboard, such as a computer keyboard, includes a plurality of keycaps 110 and keycap assemblies 100.

The keycap 110 includes an upper surface 112, a lower surface 114 and side surfaces 116. The upper surface 112 can define an opening (not illustrated), and the lower surface 114 can define an opening. In some implementations, the keycap 110 has a generally rectangular shape (when viewed from a position above the keycap). For example, in some implementations, the upper surface 112 has a rectangular or square shape.

The keycap 110 can define a passageway 120 that extends through the keycap 110 from the upper surface 112 to the lower surface 114. Specifically, in some implementations, the passageway 120 defined by the keycap 110 extends from the opening defined by the upper surface of the keycap 110 to the opening defined by the lower surface of the keycap 110.

In some implementations, the opening defined by the upper surface of the keycap 110 is in the shape of a symbol, such as an alphanumeric character. In some implementations, the opening defined by the upper surface of the keycap 110 is in the shape of a single alphanumeric character. For example, in some implementations, the opening defined by the upper surface 112 of the keycap 110 is in the shape of a letter or is letter shaped. In other implementations, the opening defined by the upper surface 112 of the keycap 110 is in the shape of a number or is number shaped. In yet other implementations, the opening defined by the upper surface 112 of the keycap 110 has the shape of another symbol, such as a symbol typically found on the keys of a computer keyboard.

In some implementations, the opening defined by the upper surface 112 of the keycap 110 forms a portion of a symbol, such as a letter or a number. For example, in some implementations, the upper surface of the keycap 110 defines a plurality of openings, the lower surface 114 of the keycap 110 defines a plurality of openings, and the keycap 110 defines a plurality of passageways extending through the keycap 110. Each of the plurality of passageways extends from an opening defined by the upper surface 112 of the keycap 110 to an opening defined by the lower surface 114 of the keycap 110.

In some implementations, the plurality of openings defined by the upper surface 112 of the keycap 110 collectively form a shape of a symbol. For example, in some implementations, the plurality of openings defined by the upper surface 112 of the keycap 110 form a single letter or alphanumeric shape. In other implementations, the plurality of openings defined by the upper surface 114 of the keycap 110 form a number shape or the shape of another symbol.

In some implementations, the upper surface 112 of the keycap 110 defines many openings. For example, in some implementations, the upper surface 112 of the keycap defines 300, 500 or more openings. The individual openings may have a circular or oval shape and may collectively form an alphanumeric symbol. In some implementations, the openings defined by the upper surface 112 of the keycap 110 are microscopic. In some such implementations, the small openings may help prevent dust, dirt, and other unwanted materials from entering the openings and passageways.

In some implementations, the keycap 110 is formed of an opaque material (i.e., light does not pass through the material). For example, in some implementations the keycap 110 is formed of a metal material. Specifically, in some implementations the keycap 110 is formed of a material that includes steel, aluminum, titanium, magnesium, copper, brass, nickel or tin. In other implementations, the keycap 110 is formed of carbon, carbon fiber, nano-tube reinforced plastic, glass, or ceramic. In some implementations, the keycap 110 is formed of a mixture of materials. In some implementations, such mixture of materials includes a metal material.

In some implementations, the keycap 110 is formed of an opaque material (such as a metal material) and a transparent material. For example, in one implementation, the opaque material of the keycap 110 defines the passageway 120 and a transparent material is coupled to the opaque material and disposed within the passageway 120 defined by the opaque material. In some implementations, the opaque material includes a metal material and the transparent material includes a plastic material.

The keycap 110 is configured to actuate the switch 150 when the keycap 110 is selected by a user. For example, in some implementations, a user may select the keycap 110 by depressing the keycap 110 (such as depressing a key on a computer keyboard). The depressed keycap 110 is configured to actuate the switch 150, which is disposed beneath the keycap 110.

In some implementations, the keycap 110 is biased to its un-depressed state. Thus, a user may apply a force to the keycap 110 to depress the keycap 110 and actuate the switch 150. Once the user releases or removes the force from the keycap 110, the keycap 110 returns to its un-depressed state or configuration. In some implementations, the keycap assembly 100 includes a keycap return mechanism that is configured to bias the keycap 110 into its un-depressed configuration. For example, the keycap return mechanism may include a hinge system or a spring that is configured to bias the keycap 110 into its un-depressed configuration.

In some implementations, the keycap assembly 100 includes a support structure that is configured to provide support to the keycap. In some implementations, the support structure is configured to help prevent the keycap from tilting. Additionally, in some implementations, the support structure is configured to bias the keycap into its un-depressed state.

The switch 150 may be any type of mechanical or electrical switch that is configured to communicate with a display or other device. For example, in some implementations, the switch 150 is an electrical switch and is configured to communicate with a computer system. Specifically, in some implementations, the switch 150 is configured to communicate with a central processing unit and a display device (monitor) or a computer system.

For example, in some implementations, the switch 150 is an electrical switch. When such a switch 150 is actuated or activated, a metal contact of the switch contacts and completes an electrical circuit to communicate to the display or other device that the switch 150 has been actuated.

The light source 160 is configured to generate light and emit light through the passageway 120 defined by the keycap 120. In some implementations, the light source 160 is disposed such that the keycap 110 is disposed between the user and the light source 160. In some implementations, the light source 160 is disposed proximate the lower surface 114 of the keycap 110. In some implementations the light source 160 is disposed such that the lower surface 114 of the keycap 110 is disposed between the light source 160 and the upper surface 112 of the keycap 110.

As the light source 160 is configured to emit light through the passageway 120 of the keycap 110, the keycap 110 will be backlight. Accordingly, as the light is emitted through the passageway and out the opening defined by the upper surface 112 of the keycap 110, the shape of the opening defined by the upper surface 112 of the keycap 110 will be illuminated to the user. Specifically, if the opening defined the upper surface 112 of the keycap 110 is letter shaped, the illumination of the keycap 110 will be shaped like the letter.

The light source 160 can be any device that generates or emits a light. For example, in some implementations, the light source 160 is can include a light guide film that guides light from a distant source to under the keycap. In other implementations, the light source 160 can include a light emitting diode positioned approximately under the keycap.

In some implementations, the light source 160 is used to emit light through passageways of a plurality of keycaps. For example, a keyboard may include ten keycaps and switches and include one light source. In such an implementation, the passageways defined by each of the keycaps are illuminated by the single light source.

In some implementations, the light emitted through the keycap 110 is directed in a specific direction. For example, in some implementations, the light emitted through the openings and passageways of the keycap 110 is directed in a direction of a user of the keyboard or computer system. In some implementations, the light emitted through the openings and passageways of the keycap 110 is directed away from non-users of the keyboard or computer system.

For example, in some implementations, the passageway 120 extends in a direction or along an axis that is normal to the upper surface 112 of the keycap 110. In other implementations, the passageways extend in a direction or along an axis that is not normal or angled with respect to the upper surface 112 of the keycap 110. For example, in some implementations, the passageways 120 are angled with respect to the upper surface 112 of the keycap 110 and are angled toward a user of the keyboard or computer system.

In some implementations, the upper surface 112 of the keycap 110 includes many openings and passageways that extend to openings defined by the lower surface 114 of the keycap 110. In some implementations, the ratio of the length of the passageways (i.e., the thickness of the keycap 110) to the diameter or width of the openings defined by the upper surface 112 is sufficient for light to pass through the passageway. In some implementations, the ratio of the length of the passageways to the diameter of the openings defined by the upper surface is sufficient to allow light to be transmitted through the passageways towards a user located in front of the keyboard or computer system and away from the sides of the keyboard.

In some such implementations, the passageways (i.e., the thickness of the keycap 110) have a length of about 1 mm. In other implementations, the passageways (i.e., the thickness of the keycap 110) have a length of less than about 0.5 mm. For example, in some implementations, the passageways (i.e., the thickness of the keycap 110) have a length of between 0.2 mm and 0.5 mm. In some implementations, the openings in the upper surface 112 of the keycap 110 are circular and the diameter of the openings are less than 1 mm.

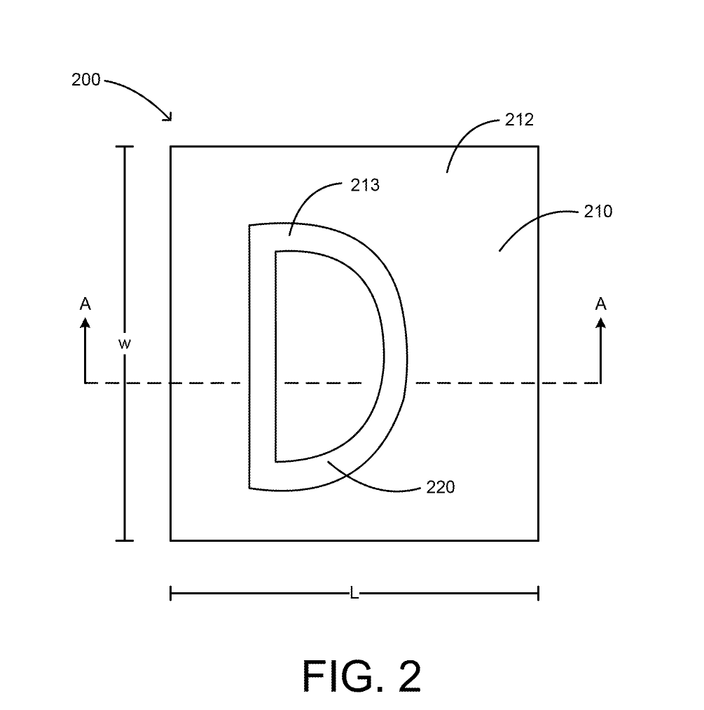

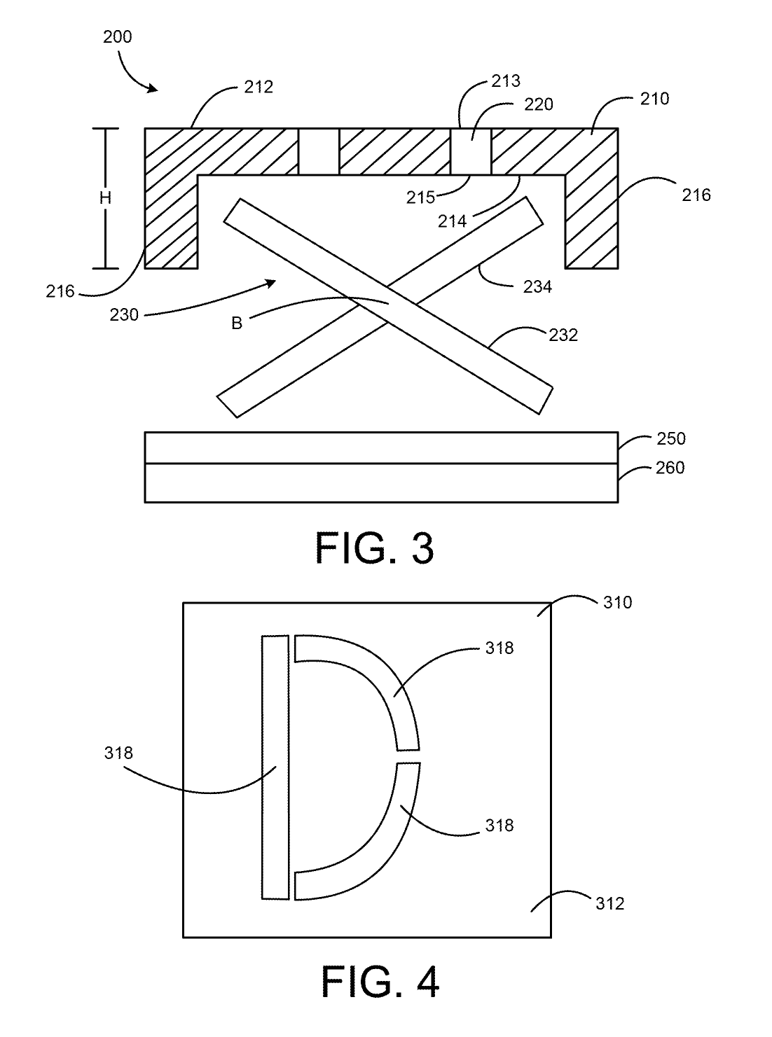

FIG. 2 is a top view of a keycap assembly 200. FIG. 3 is a schematic cross-sectional view of the keycap assembly 200 taken along line A-A of FIG. 2. The keycap assembly 200 includes a keycap 210, a switch 250, and a light source 260.

The keycap 210 includes an upper surface 212, a lower surface 214, and side surfaces 216. The upper surface 212 defines an opening 213. In the illustrated implementation, the opening 213 defined by the upper surface 212 is in the shape of the letter D.

The lower surface 214 of the keycap 210 defines an opening 215. The keycap 210 defines a passageway 220 that extends through the keycap 210 from the opening 213 defined by the upper surface 212 to the opening 215 defined by the lower surface 214.

In the illustrated implementation, the keycap 210 is formed of an opaque material. Specifically, the keycap 210 is formed of a metal material. For example, in some implementations the keycap 210 is formed of a material that includes steel, aluminum, titanium, magnesium, copper, brass, nickel, or tin. In some implementations, the keycap 210 is formed of a mixture of materials. In some implementations, such mixture of materials includes a metal material.

The keycap 210 is configured to actuate the switch 250 when the keycap 210 is selected by a user. In the illustrated implementation, a user may select the keycap 210 by depressing the keycap 210 (such as depressing a key on a computer keyboard). The depressed keycap 210 is configured to actuate the switch, which is disposed beneath the keycap 210.

In the illustrated implementation, the keycap assembly 200 includes a keycap return mechanism 230. The keycap return mechanism 230 is configured to return the keycap 210 to its normal state after being depressed by a user. In other words, the keycap return mechanism 230 is configured to bias the keycap 210 into a non-depressed state.

The keycap return mechanism 230 is a scissor type structure and includes a first arm 232 and a second arm 234 that is pivotally coupled to the first arm 232 at B. The first arm 232 and the second arm 234 are pivotally coupled to a base member (not illustrated) disposed below the keycap return mechanism 230. In some implementations, the keycap return mechanism 230 is coupled, such as pivotally coupled, to the keycap 210.

The keycap return mechanism 230 is biased to an upright or expanded configuration and may, upon the application of a force be placed in a collapsed configuration. Thus, when the keycap 210 is depressed by a user, the application of force causes the keycap return mechanism 230 to be placed in its collapsed configuration. The removal of the force (for example, when a user is no longer depressing the keycap 210) causes the keycap return mechanism 230 to return to its expanded configuration and thus, causes the keycap 210 to return to its non-depressed state. The keycap return mechanism 230 also provides support to the keycap and helps prevent the keycap from tilting.

As illustrated in FIGS. 3A and 3B, in some implementations, the keycap 210 is a cantilever keycap. Specifically, in the illustrated implementation, the keycap 210 is unitarily formed or integral with the material that forms an upper surface 201 of a keyboard. FIG. 3A is a top view of a portion of a keyboard and a keycap assembly and FIG. 3B is a cross-sectional view of the portion of the keyboard and keycap assembly of FIG. 3A.

The material that forms the upper surface 201 of the keyboard defines an opening 203. The opening 203 defines the keycap 210. In the illustrated implementation, the opening 203 is generally “U” shaped and surrounds or defines threes sides of the keycap 210. In other implementations, the opening 203 is of a different shape and surrounds more or less of the keycap 210.

The keycap 210 includes a flexible or bendable portion 211 that is configured to flex or bend when a force in the direction of F, such as a user depressing the keycap 210, is applied to the keycap 210. Accordingly, the keycap 210 is configured to actuate the switch 271 of the keyboard when a force in the direction of F is applied to the keycap 210. The flexible or bendable portion 211 of the keycap 210 biases the keycap 210 to its non-depressed state. Accordingly, the keycap 210 returns to its non-depressed state when the force is removed from the keycap 210.

In the illustrated implementation, the upper surface 212 of the keycap 210 has a width W. In some implementations, the upper surface 212 forms a rectangle when viewed from the top of the keycap 210. In some implementations, the width W of the upper surface 212 of the keycap 210 is about 8 mm. In other implementations, the width W of the upper surface 212 of the keycap 210 is less than 8 mm. In yet further implementations, the width W of the upper surface 212 of the keycap 210 is greater than 8 mm. For example in some implementations, the width W of the upper surface is between about 8 mm and 20 mm.

In the illustrated implementation, the upper surface 212 of the keycap 210 has a length L. In some implementations, the length L of the upper surface 212 of the keycap 210 is about 8 mm. In other implementations, the length L of the upper surface 212 of the keycap 210 is less than 8 mm. In yet further implementations, the length L of the upper surface 212 of the keycap 210 is greater than 8 mm. For example, in some implementations, the length L of the upper surface 212 of the keycap 210 is between 8 mm and 20 mm or 8 mm and 110 mm.

In the illustrated implementation, the side surface 216 of the keycap 210 has a height H. In some implementations, the height of the side surface 216 of the keycap 210 is about 0.5 mm. In other implementations, the height H of the side surface 216 of the keycap 210 is less than 0.5 mm (such as between 0.2 mm and 0.5 mm). In yet further implementations, the height H of the side surface 216 of the keycap 210 is greater than 0.5 mm.

The switch 250 may be any type of mechanical or electrical switch that is configured to communicate with a display or other device. In the illustrated implementation, the switch 250 is an electrical switch. When such a switch 250 is actuated or activated, a metal contact (not illustrated) of the switch contacts and completes an electrical circuit (not illustrated) to communicate to the display or other device that the switch 250 has been actuated.

The light source 260 is configured to generate light and emit light through the passageway 220 defined by the keycap 210. The light source 260 is disposed such that the keycap 210 is disposed between the user and the light source 260. The light source 260 is disposed proximate the lower surface 214 of the keycap 210. Specifically, the light source 260 is disposed such that the lower surface 214 of the keycap 210 is disposed between the light source 260 and the upper surface 212 of the keycap 210.

As the light source 260 is configured to emit light through the passageway 220 of the keycap 210, the keycap 210 is backlight. Accordingly, as the light is emitted through the passageway 220 and out the opening 213 defined by the upper surface 212 of the keycap 210, the shape of the opening 213 defined by the upper surface 212 of the keycap 210 will be illuminated to the user. In the illustrated implementation, the letter “D” is illuminated to the user.

The light source 260 can be any device that generates or emits a light. In the illustrated implementation, the light source 260 is a light guide film.

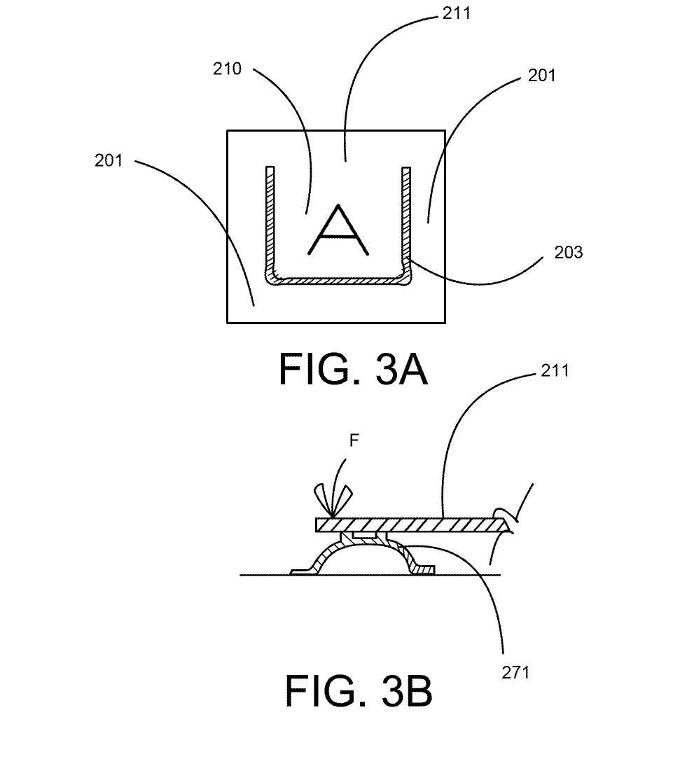

FIG. 4 is a top view of another keycap 310. The keycap 310 includes an upper surface 312. The upper surface 312 of the keycap 310 defines a plurality of openings 318. The openings 318 defined by the upper surface 312 of the keycap 310 collectively define a symbol. In the illustrated implementation, the openings 318 defined by the upper surface 312 of the keycap 310 define the letter “D.”

The keycap 310 defines passageways that extend through the openings 318 defined by the upper surface 312 of the keycap 310 and through the thickness of the keycap 310. Thus, a light source may emit light through the passageways and through the plurality of openings 318 defined by the upper surface 312 of the keycap 310.

The upper surface of the keycap may define any number of openings. For example, the upper surface of the keycap may define 2, 3, 4, or more openings. The openings collectively may form a shape of a symbol. In some implementations, the openings defined by the upper surface of the keycap are microscopic. In other words, the individual openings are not individually visible to the naked eye, but collectively may be perceived as the symbol which they collectively form.

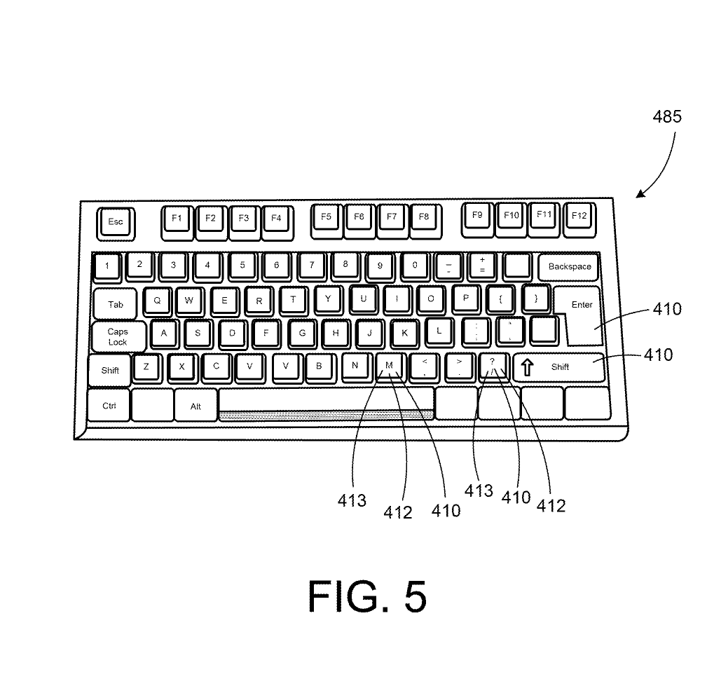

FIG. 5 is a top view of a keyboard 485. The keyboard 485 may be coupled to and communicate with a computer or any other device. The keyboard 485 includes a plurality of keycaps 410. Each of the keycaps 410 is configured actuate a different switch (not illustrated). In the illustrated implementation, the keycaps 410 includes upper surfaces 412 that define openings 413 that form symbols.

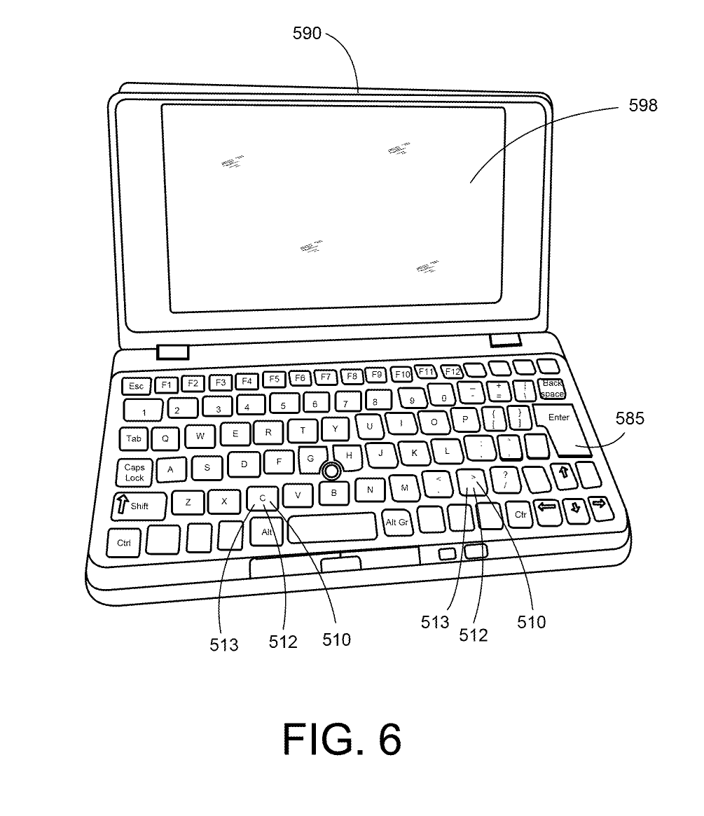

FIG. 6 is a perspective view of a laptop computer 590 that includes a keyboard 585 and a screen 595. The keyboard 585 includes a plurality of keycaps 510. Each of the keycaps 510 is configured actuate a different switch (not illustrated). In the illustrated implementation, the keycaps 510 includes upper surfaces 512 that define openings 513 that form symbols.

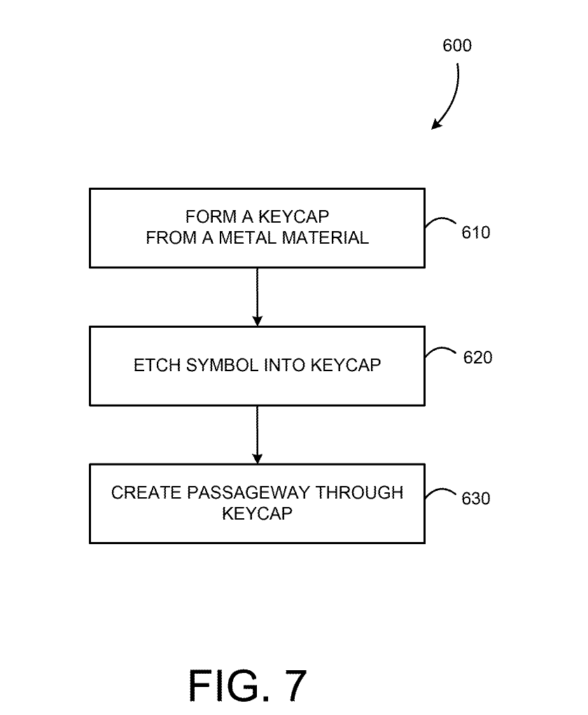

FIG. 7 is a flow chart that illustrates a method 600 for forming a keycap. At step 610, the keycap is formed. The keycap may be formed of an opaque material such as a metal material. The keycap may be formed by molding or machining or any other known method for forming objects of a metal material.

At step 620, the keycap is etched to include the symbol that will be represented by the keycap. For example, the keycap may be etched to include a letter, a number, or another symbol.

At step 630, the keycap a passageway is formed through the keycap. In some implementations, the passageway extends from an upper surface of the keycap to a lower surface of the keycap. In some implementations, the passageway is formed by drilling below the etched portion of the keycap. In some implementations, the passageway is microdrilled using a laser. In other implementations, the passageway is formed using another known method or tool.

In some implementations, more than one passageway is formed through the keycap. For example, in some implementations, a plurality of microscopic passageways are foamed through the keycap. The openings defined by the upper surface of the keycap collectively form a symbol such as a letter, a number, or another symbol.

For example, an etching process may be used to form the passageway or passageways of the keycap. To etch the keycap a typical etching process may be used. The metal keycap may be covered with a resist or ground material that is resistant to acid. The resist or ground material is then removed from desired portions of the keycap. The keycap is then exposed to an acid material that will eat or dissolve the metal material of the keycap that is not covered with the resist. Accordingly, in this implementation, the acid material can be used to form the openings and passageways of the keycap.

In some implementations, a sheet of keycaps are formed, stamped out, and then etched individually. In other implementations, a sheet of material is etched with the characters of many keycaps and the keycaps are then stamped from the etched material.

In some implementations, the method includes disposing a translucent material into the passageway defined by the keycap. In some implementations, the translucent material is a clear plastic. In some implementations, the method includes treating the surface of the metal material of the keycap to allow a plastic material to adhere to the metal surface and then adhering the plastic material to the metal material. In some implementations, the translucent material is nano-injected into the passageway defined by the passageway of the keycap.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A device comprising:
a laptop computer having a full-size QWERTY keyboard including:
a plurality of keycaps disposed in first and second rows of keycaps, the first row of keycaps being horizontally offset from the second row of keycaps such that the keycaps of the first row of keycaps partially overlap the keycaps of the second row of keycaps, each keycap having end portions with linear and parallel edges where end portions of each keycap are horizontally offset from end portions of each other keycap, each keycap configured to actuate a different switch of the computing device, each keycap including a metal material and having an upper surface and a lower surface, the upper surface of each keycap configured to be viewed by a user while operating the computing device and defining a plurality of openings in each keycap, the openings in the upper surface of each keycap being patterned in a shape of a single alphanumeric character, the lower surface of each keycap defining a plurality of openings in each keycap, each keycap defining a plurality of microscopic passageways extending from the openings defined by the upper surface of each keycap through each keycap to the openings defined by the lower surface of each keycap; and
at least one light source configured to emit light through each of the microscopic passageways of each keycap from the lower surface side of the microscopic passageways to the upper surface side of the microscopic passageways, the light source including a single light guide film configured to guide light from the light source to each keycap.

2. The device of claim 1, wherein the metal material includes at least one of steel, aluminum, iron, titanium magnesium, copper, brass, nickel, and tin.

3. The device of claim 1, wherein the at least one light source is disposed proximate the lower surface of each keycap.

4. The device of claim 1, wherein the keyboard is configured to communicate with a visual display.

5. The device of claim 1, wherein each keycap has a height of less than about 0.5 mm.

6. The device of claim 1, wherein a transparent material is coupled to each keycap and disposed within at least a portion of each microscopic passageway defined by each keycap.

7. The device of claim 1, wherein each keycap is cantilevered from an upper surface of the keyboard.

8. The device of claim 1, wherein each keycap and an upper surface of the keyboard are monolithically formed.

9. The device of claim 1, wherein the microscopic passageways extend a distance of less than 0.5 mm.

10. A laptop computer, comprising:
a full-size QWERTY keyboard including:
a plurality of keycaps disposed in first and second rows of keycaps, the first row of keycaps being horizontally offset from the second row of keycaps such that the keycaps of the first row of keycaps partially overlap the keycaps of the second row of keycaps, each keycap having end portions with linear and parallel edges where end portions of each keycap are horizontally offset from end portions of each other keycap, each keycap including:
an upper surface defining one or more openings, the one or more openings defined by the upper surface forming an alphanumeric character, the upper surface having a rectangular shape;
a lower surface defining one or more openings; and
a side surface,
each of the keycaps being configured to actuate a different switch of the keyboard of the laptop computer, each of the keycaps including a metal material and defining a plurality of microscopic passageways extending from the one or more openings defined by the upper surface through each of the keycaps to the one or more openings defined by the lower surface, and
each of the keycaps being arranged in a layered structural orientation such that each of the switches are interposed between the lower surface of each of the keycaps and a light source configured to illuminate each of the keycaps.

11. The laptop computer of claim 10, wherein the upper surface has a width of between about 8 mm and 20 mm, a length of between about 8 mm and 20 mm, the side surface has a height of less than about 0.5 mm.

12. The laptop computer of claim 10, wherein each keycap is formed of at least one of the following steel, aluminum, iron, titanium, magnesium, copper, brass, nickel, and tin.

13. The laptop computer of claim 10, further comprising:
a transparent material disposed within at least a portion of the microscopic passageways defined by each keycap.

14. The laptop computer of claim 10, wherein each keycap is cantilevered from an upper surface of the keyboard.

15. The laptop computer of claim 10, wherein each keycap and an upper surface of the keyboard are monolithically formed.

16. The laptop computer of claim 10, wherein the microscopic passageways extend a distance of less than about 0.5 mm.

17-22. (canceled)

23. The device of claim 1, wherein the light source includes the single light guide film configured to illuminate the keycaps, and each keycap, each switch, and the single light guide film are assembled in a layered structural orientation such that each switch is interposed between each keycap and the single light guide film.

24. The device of claim 1, wherein:
the plurality of microscopic passageways are formed in each keycap to define the one or more openings patterned in the shape of the single alphanumeric character, and
the light source is configured to emit light through the microscopic passageways of each keycap to illuminate the shape of the single alphanumeric character.

25. The laptop computer of claim 10, wherein the plurality of microscopic passageways are formed in each keycap to define the one or more openings forming the alphanumeric character.

26. The device of claim 1, wherein the light source includes a single light source, and the single light guide film is configured to guide light from the single light source to each keycap.

27. The laptop computer of claim 10, wherein the light source includes a single light guide film configured to illuminate each keycap.

28. The device of claim 1, wherein each of the microscopic passageways are angled toward the user of the keyboard.

29. The device of claim 1, wherein the light source is configured to illuminate each keycap separate from switch actuation.
